(19) United States
(12) Patent Application Publication
(10) Pub. No.: US 2005/0124280 A1
(43) Pub. Date: Jun. 9, 2005

(54) Coin dispenser and control method for the coin dispenser

(76) Inventors: Eiji Itako, Saitama (JP); Mitsugu Mikami, Saitama (JP); Tsunehiro Aso, Saitama (JP)

Correspondence Address: WELSH & KATZ, LTD, 120 S RIVERSIDE PLAZA, 22ND FLOOR, CHICAGO, IL, 60606, US

(21) Appl. No.: 10/490,401

(22) PCT Filed: Jul. 3, 2003
(86) PCT No.: PCT/JP03/08448

(30) Foreign Application Priority Data
Jul. 26, 2002 (JP) 2002-218351

(51) Int. Cl. G07D 1/00

(52) U.S. Cl. 453/18

(57) ABSTRACT

A coin dispenser capable of shortening a coin delivery time and extending the operation life of a coin delivery mechanism part by reducing the number of idle striking operations and a control method for the coin dispenser, the method comprising the steps of, based on the counted results of a deliverability counter for counting coins accumulated in coin tubes for each coin tube, detecting, as the idle-struck coin tube, the coin tube in which a coin is newly accumulated when the number of the accumulated coins is less that a specified quantity and, when delivering the coins, performing the idle striking operation for performing a delivery operation in the state of prohibiting the delivery of the coins from the coin tube only when the idle-struck coin tube is detected.

### TECHNICAL FIELD

The present invention relates to a coin dispenser disposed within equipment such as an automatic vending machine and a control method for the coin dispenser, and more particularly to a coin dispenser, which is configured to be capable of remedying a delivery error resulting from a coin standing on its edge caused when a single coin of a pertinent coin type is put in a coin tube of the coin dispenser, and a control method for the coin dispenser.

### BACKGROUND ART

It is general that a coin dispenser, which checks whether an inserted coin is authentic or counterfeit and delivers coins corresponding to an amount of change, is disposed in equipment such as automatic vending machines, ticket machines and the like.

Such a coin dispenser is generally comprised of a coin dividing part which determines the authenticity of inserted coins and divides into genuine and counterfeit coins, a coin holding part which stores accumulated coins which are determined as authentic, and a coin delivery part which delivers coins according to an amount of change from the coin holding part.

The coin holding part has a plurality of coin tubes for holding individual coins by coin type, which are divided and determined as genuine coins by the coin dividing part.

And, the coin delivery part comprises a delivery slide which is disposed below the coin tubes of the above-described coin holding part and pull out coins one by one in a state held in coin holding holes from the bottom ends of the coin tubes and change slides which are disposed below the delivery slide and operate to conduct and control drop delivery of the coins, which are pulled out by the delivery slide, from the coin holding holes.

When only one coin of a pertinent coin type is introduced when its coin tube is empty, such a type of coin dispenser has a possibility of causing a standing coin that the coin is in a state of standing on its edge in the pertinent coin tube.

If a coin delivery directive is given to the standing coin, the pertinent coin which is not held in the coin holding hole cannot be delivered even if the coin delivery operation is made.

Therefore, in such a situation, measures are taken to perform an operation called idle striking with coins of all coin types held in a non-delivery state to lay the standing coin down so to hold it in the coin holding hole, then the pertinent coin is actually delivered.

Generally, the conventional device of such a type performs the above-described idle striking operation for every delivery before the pertinent coin is delivered.

As described above, the conventional device which performed the idle striking operation every time the delivery was performed had disadvantages that the coin delivery operation took time, and the number of operations of individual mechanisms related to the coin delivery increased, resulting in shortening the operation lives of the respective mechanisms.

### DISCLOSURE OF THE INVENTION

In view of the circumstances described above, the present invention is to remedy the above-described disadvantages and provides a coin dispenser, which can assure the delivery of coins by a minimum idle striking operation even if a coin stands on its edge, shorten the coin delivery time by reducing the number of idle striking operations and extend the operation lives of coin delivery mechanisms, and a control method for the coin dispenser.

In order to achieve the above object, the invention of claim 1 provides a coin dispenser which includes a plurality of coin tubes for storing inserted coins by coin type and coin delivery means for selectively delivering coins from bottom ends of the coin tubes, comprising: coin counter means for counting coins accumulated in each of the coin tubes; detection means for detecting, as an idle struck coin tube, a coin tube having a prescribed number or less of accumulated coins, in which another coin is newly accumulated, according to count outputs of the coin counter means; and delivery control means for executing, at the time of delivering coins by the coin delivery means, an idle striking operation in which a delivery operation is performed in a state that coins are prohibited to be delivered from the idle struck coin tube, only when the idle struck coin tube is detected by the detection means.

The invention described in claim 2 relates to the invention of claim 1, wherein the coin delivery means comprises: coin delivery motor; a delivery slide which is driven by the coin delivery motor to pull out coins from the bottoms of the coin tubes one by one; delivered coin selecting solenoids each being provided in association with each of the coin tubes; and change slides which are selectively driven according to ON/OFF of the delivered coin selecting solenoids and which control delivery and non-delivery of the pulled-out of coins by switching between a state of releasing and a state of supporting bottom faces of the coins of respective coin types pulled out by the delivery slide, and the delivery control means executes the idle striking operation by rotating the coin delivery motor while holding the change slide in the bottom face supporting state by means of the delivered coin selecting solenoid associated with the idle struck coin tube.

The invention described in claim 3 relates to the invention of claim 1, wherein the detection means detect a coin tube, which has been empty and received a coin newly, as an idle struck coin tube.

The invention described in claim 4 relates to the invention of claim 1, wherein the delivery control means cancels the detection of the idle struck coin tube when a coin is delivered from another coin tube after the idle struck coin tube is detected by the detection means.

The invention described in claim 5 is a method for controlling a coin dispenser which accumulates inserted coins in a plurality of coin tubes separately by coin type and selectively delivers the coins from bottom ends of the plurality of coin tubes, the method comprising: counting the coins accumulated in each of the coin tubes; detecting a coin tube, which has a prescribed number or less of accumulated coins and received a coin newly, as an idle struck coin tube according to the counted result; and executing, at the time of delivering coins by the coin delivery means, an idle striking operation in which a delivery operation is performed in a state that coins are prohibited to be delivered from the idle struck coin tube, only when the idle struck coin tube is detected.

The invention described in claim 6 relates to the invention of claim 5, wherein: a delivery slide, which pulls out coins one by one from bottom ends of the coin tubes, is driven by means of a coin delivery motor, and change slides are switched between a state of releasing and a state of supporting the coins of respective coin types pulled out by the delivery slide according to ON/OFF of delivered coin selecting solenoids each provided in association with each of the coin tubes, so as to control delivery and non-delivery of the pulled-out coin; and the idle striking operation is executed by rotating the coin delivery motor while holding the change slide in the bottom face supporting state by means of the delivered coin selecting solenoid associated with the idle struck coin tube.

The invention described in claim 7 relates to the invention of claim 5, wherein the idle struck coin tube is a coin tube which has been empty and received one coin newly.

The invention described in claim 8 relates to the invention of claim 5, wherein the detection of the idle struck coin tube is cancelled when a coin is delivered from another coin tube after the idle struck coin tube is detected by the detection means.

According to the configuration of the present invention, the idle striking operation to make the delivery operation with the delivery of a coin from the coin tube prohibited is performed only when a coin tube having a prescribed number or less of accumulated coins and having received another coin is detected as the idle struck coin tube and the idle struck coin tube is detected to deliver a coin by coin delivery means. Therefore, it is not necessary to perform the idle striking operation for every coin delivery, the coin delivery time can be shortened substantially, and the number of idle striking operations is reduced. Thus, the operation lives of the respective mechanisms related to the coin delivery can be extended, and the reliability of the coin delivery processing can be improved.

### BRIEF DESCRIPTION OF THE DRAWINGS

FIG. 1 is a conceptual side structure diagram of the main portions in a coin dispenser according to the invention,

FIG. 2 is a diagram showing a conceptual perspective structure with the main portions broken of a coin delivery part of the coin dispenser according to the invention,

FIG. 3 is a conceptual sectional diagram with the main portions broken of the coin dispenser according to the invention,

FIG. 4 is a block diagram showing a schematic structure of a control system of the coin dispenser according to the invention,

FIG. 5 is a diagram illustrating a coin delivery operation from a coin delivery part of the coin dispenser,

FIG. 6 is a diagram illustrating the coin delivery operation from the coin delivery part subsequent to FIG. 6,

FIG. 7 is a diagram illustrating the coin delivery operation of another embodiment from the coin delivery part,

FIG. 8 is a diagram illustrating the coin delivery operation of still another embodiment from the coin delivery part,

FIG. 9 is a diagram illustrating a coin delivery operation from the coin delivery part subsequent to FIG. 8,

FIG. 10 is a diagram illustrating the coin delivery operation from the coin delivery part subsequent to FIG. 9,

FIG. 11 is a flow chart showing the inserted coin processing of the coin dispenser according to the invention,

FIG. 12 is a table showing an example of coin delivery control data in a coin delivery control part,

FIG. 13 is a flow chart showing a coin delivery operation of the coin delivery control part,

FIG. 14 is a diagram showing an example of coin delivery control data used for the coin delivery operation, and

FIG. 15 is a diagram showing an example of coin delivery control data used for the coin delivery operation of another embodiment.

### BEST MODE FOR CARRYING OUT THE INVENTION

Embodiments of the coin dispenser according to the present invention will be described in detail with reference to the accompanying drawings.

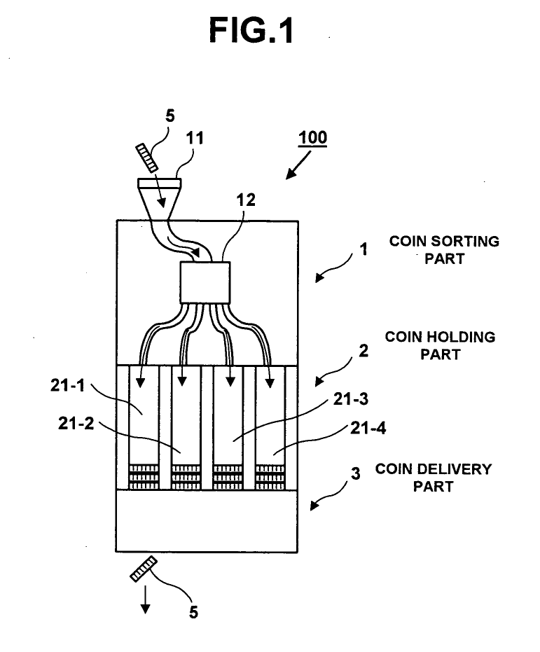

FIG. 1 is a diagram showing a conceptual side structure of the main portions in a coin dispenser 100 according to the invention.

The coin dispenser 100 comprises a coin sorting part 1 which guides coins 5 (four types of coins, 500 yen, 100 yen, 50 yen and 10 yen are handled in this case) dropped through a coin insertion port 11 to an authenticity determination/sorting part 12, determines the inserted coins 5 for their authenticity and coin type by the authenticity determination/sorting part 12 and sorts the authentic coins according to coin types, a coin holding part 2 which is disposed below the coin sorting part 1 and consists of a plurality of coin tubes 21 (500 yen tube 21-1, 100 yen tube 21-2, 50 yen tube 21-3 and 10 yen tube 21-4) for holding the coins by coin type which are sorted according to coin types by the coin sorting part 1, and a coin delivery part 3 which selects to deliver the coins 5 corresponding to the amount of change from the coin tubes 21 for the respective coin types in the coin holding part 2.

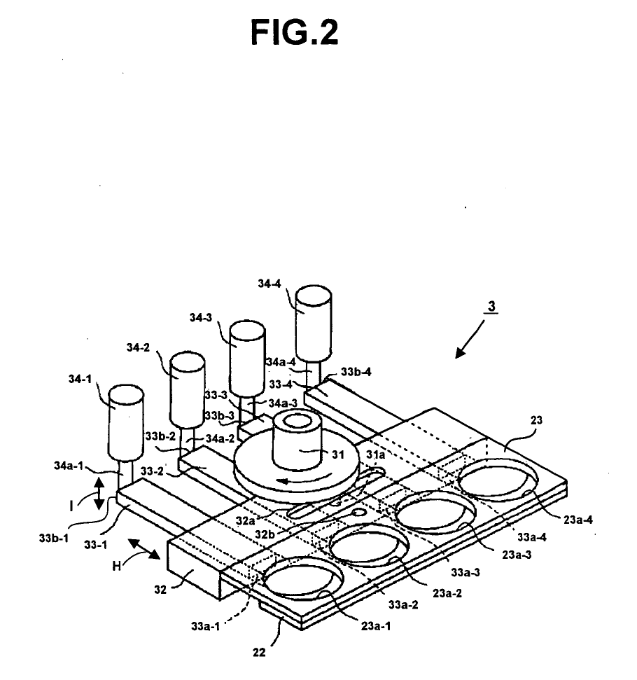

FIG. 2 is a diagram showing a conceptual perspective structure with the main portions broken of the coin delivery part 3 in the coin dispenser 100.

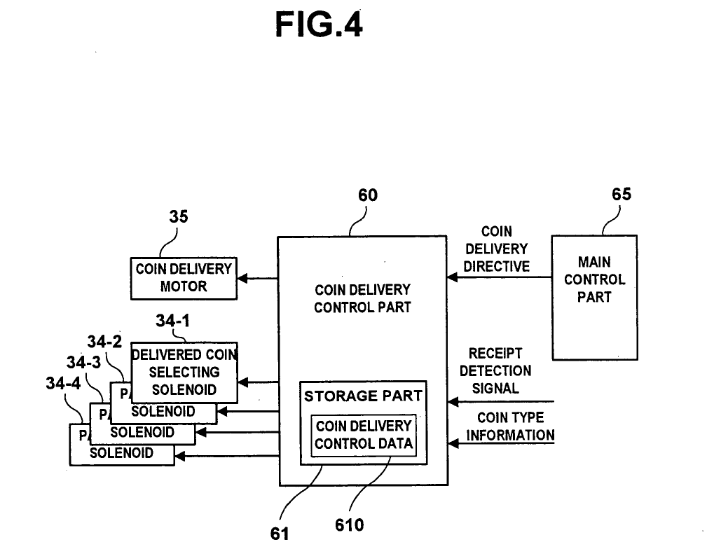

As shown in FIG. 2, the coin delivery part 3 is comprised of a delivery cam 31 which makes one turn in one direction (clockwise direction indicated by an arrow in the drawing) for each delivery operation through an unshown coin delivery motor 35 (see FIG. 4) and power transmission means such as unshown gears for transmitting a drive force of the coin delivery motor 35, a delivery link 32 which has a groove 32a for engagement with a pin 31a protruded from the bottom face of the delivery cam 31 and moves reciprocally in a direction indicated by arrow H from the initial position in the drawing when the delivery cam 31 makes a single turn in the arrow direction (clockwise direction), and a delivery slide 23 which is detachably engaged to the delivery link 32 via a pin 32b and reciprocally moved in a direction of arrow H by being driven to follow the reciprocating movement of the delivery link 32.

The delivery slide 23 is formed to have coin holding holes 23a-1, 23a-2, 23a-3, 23a-4 each for holding only one coin which is held at the bottom level in unshown coin tubes 21-1, 21-2, 21-3, 21-4 configuring the coin holding part 2.

A bottom plate (coin base) 22 is disposed on the lower sides of the individual coin holding holes 23a-1, 23a-2, 23a-3, 23a-4 to partly cover the bottom face of the delivery slide 23 in the initial position of FIG. 2 so to prevent the coins held in the individual coin holding holes 23a-1, 23a-2, 23a-3, 23a-4 from dropping.

Meanwhile, change slides 33-1, 33-2, 33-3, 33-4 each having the leading end approached to the lower sides of the individual coin holding holes 23a-1, 23a-2, 23a-3, 23a-4 of the delivery slide 23 to control delivery and non-delivery of individual coins housed in the individual holes 23a-1, 23a-2, 23a-3, 23a-4 are inserted to fit into the delivery link 32 so to be freely retractable.

The change slides 33-1, 33-2, 33-3, 33-4 are so disposed that the leading end 33a-1 of the change slide 33-1 goes into the hole 23a-1, the leading end 33a-2 of the change slide 33-2 goes into the hole 23a-2, the. leading end 33a-3 of the change slide 33-3 goes into the hole 23a-3, and the leading end 33a-4 of the change slide 33-4 goes into the hole 23a-4.

And, rear ends 33b-1, 33b-2, 33b-3, 33b-4 of the individual change slides 33-1, 33-2, 33-3, 33-4 are engaged with change levers 34a-1, 34a-2, 34a-3, 34a-4 which are plungers of delivered coin selecting solenoids 34-1, 34-2, 34-3, 34-4 independently provided for the individual slides 33-1, 33-2, 33-3, 33-4, and normally limited their movements.

According to the coin delivery part 3 configured as described above, for example, when a signal (coin delivery directive) to deliver one coin (e.g., 500 yen coin) which is housed in the coin holding hole 23a-1 is input to an unshown coin delivery control part 60 (see FIG. 4), the unshown coin delivery motor 35 is driven according to the delivery signal, and the delivery cam 31 is turned to make one turn in the arrow direction by its turning force. Thus, the delivery slide 23 reciprocally moves in a direction of the arrow H to attempt to drop the individual coins housed in the individual coin holes 23a-1, 23a-2, 23a-3, 23a-4 of the delivery slide 23 one by one from the bottoms of the individual holes 23a-1, 23a-2, 23a-3, 23a-4. However, according to the delivery signal for delivering one coin housed in the coin holding hole 23a-1, since only the change lever 34a-1 of the delivered coin selecting solenoid 34-1 which limits the movement of the rear end 33b-1 of the change slide 33 -1 moves vertically as indicated by arrow I to release the engagement with the rear end 33b-1 of the change slide 33-1, only the change slide 33-1 slides backward in synchronization with the movement of the delivery cam 32 so to keep open the bottom of the hole 23a-1. Thus, the coin housed in the hole 23a-1 is dropped down from the hole 23a-1 and delivered.

The other change slides 33-2, 33-3, 33-4 have their rear ends limited from moving by the individual change levers 34a-2, 34a-3, 34a-4, so that the leading ends 33a-2, 33a-3, 33a-4 of the individual change slides 33-2, 33-3, 33-4 enter the bottoms of the holes 23a-2, 23a-3, 23a-4 so not to open them. Therefore, the coins housed in the other coin holding holes 23a-2, 23a-3, 23a-4 are not dropped from the bottoms of the holes 23a-2, 23a-3, 23a-4 and delivered even if the delivery slide 23 moves reciprocally in the direction of arrow H.

Specifically, the above described coin delivery part 3 is so configured that the any of the change levers 34a-1, 34a-2, 34a-3 or 34a-4 corresponding to the coin to be delivered is moved (upward) to release the limitation of movement of the change slide corresponding to the coin to be delivered whereby that coin can be delivered.

To deliver a plurality of coins of the same coin type, the change lever of any delivered coin selecting solenoids 34-1, 34-2, 34-3 and 34-4 corresponding to the coins to be delivered is moved (upward) to release the limitation of the corresponding one of the change slides 33-1, 33-2, 33-3 and 33-4, and then the delivery slide 23 is reciprocally moved for the number of times corresponding to the number of coins to be delivered. To deliver a plurality of coins of multiple coin types at the same time, the change levers 34a-1, 34a-2, 34a-3 and 34a-4 of two or more of the delivered coin selecting solenoids 34-1, 34-2, 34-3, 34-4 corresponding to the to-be-delivered coins of multiple coin types are moved (upward) at the same time to release the limitation of the corresponding ones of the change slides 23 for the to-be-delivered coins of multiple coin types so to enable to deliver the coins of multiple coin types at the same time.

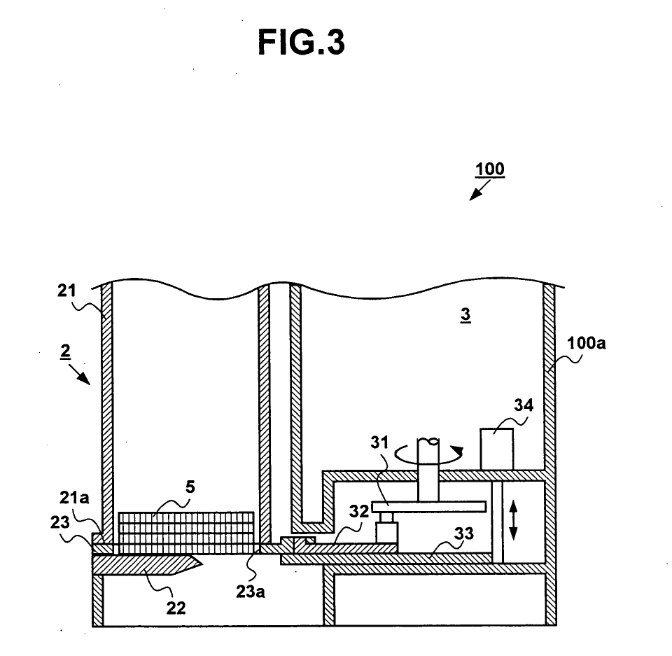

FIG. 3 is a conceptual sectional diagram with the main portions broken of the coin dispenser 100 according to the invention and especially shows conceptually the above-described coin holding part 2 and coin delivery part 3.

Referring to FIG. 3, the configurations of the coin holding part 2 and the coin delivery part 3 will be described in further detail. The coin dispenser 100 is detachably provided with the coin holding part 2, which is comprised of the plural coin tubes 21 (21-1, 21-2, 21-3, 21-4 in FIG. 2: the coin tubes 21 referred to in the description below indicate those four) provided for individual coin types, in a unit main body 100a formed of a housing.

The delivery slide 23, which pulls out the coins accumulated in the coin tubes 21 one by one, is slidably supported between a bottom end 21a of each coin tube 21 and the coin base 22 fixed below each coin tube 21.

The delivery slide 23 is formed to have the coin holding holes 23a (23a-1, 23a-2, 23a-3, 23a-4 in FIG. 2) each for housing only one of the coins 5 accumulated in the coin tubes 21.

Meanwhile, the coin delivery part 3 is comprised of the delivery cam 31 having a disc shape which is disposed in a lower part of the unit main body 100a and rotated by the coin delivery motor 35 (see FIG. 4), the delivery link 32 which slides reciprocally in the right and left directions in the drawing in synchronization with the cam 31, and the plural change slides 33 (33-1, 33-2, 33-3, 33-4 in FIG. 2) which are disposed below the delivery link 32 for the individual coin tubes 21 to selectively make support and release of the bottom face of the coin pulled out by the delivery slide 23 so to control the delivery and non-delivery of the coin.

The delivery link 32 and the delivery slide 23 are mutually linked in a concave-convex engagement by the pin 32b shown in FIG. 2 when the coin holding part 2 is attached to the unit main body 100a.

The delivered coin selecting solenoids 34 (34-1, 34-2, 34-3, 34-4 in FIG. 2) for controlling the drive of the change slides 33 are disposed at the rear ends (33b-1, 33b-2, 33b-3, 33b-4 in FIG. 2) of the individual change slides 33.

FIG. 4 is a block diagram showing a schematic structure of the control system for the coin dispenser 100 according to the present invention.

This control system for the coin dispenser 100 is comprised of a main control part 65 which controls the entire coin dispenser 100 by issuing a coin delivery directive for instructing the delivery of coins of individual coin types corresponding to an amount of change when, for example, it is necessary to deliver change from the coin dispenser 100 at the time of selling an article by an automatic vending machine, and the coin delivery control part 60 which controls the coin delivery by driving the coin delivery motor 35 and the delivered coin selecting solenoids 34-1, 34-2, 34-3, 34-4 for the individual coin types according to the coin delivery directive from the main control part 65.

The coin delivery control part 60 creates coin delivery control data 610 in a storage part 61 according to the coin delivery directive from the main control part 65 and coin type information from the authenticity determination/sorting part 12 in the configuration of FIG. 1 or receipt detection information or the like from a pass sensor (not shown) and performs the above-described coin delivery control according to the coin delivery control data 610.

In this case, the authenticity determination/sorting part 12 detects that the inserted coins are authentic (also determines their coin types), sorts the coins detected as the authentic coins to the authentic coin portion by a genuine/counterfeit coin dividing lever and detects the coins passing through the authentic coin portion by the pass sensor.

By the above operation, the coin type information recognized by the authenticity determination/sorting part 12 and the receipt detection information detected by the pass sensor are sent to the coin delivery control part 60.

The coin delivery control part 60 recognizes according to the coin type information from the authenticity determination/sorting part 12 and the receipt detection information from the pass sensor that the coins of coin types corresponding to the coin type information are received and counts the received money of pertinent coin types.

Then, a typical coin delivery operation of the coin delivery part 3 in the coin dispenser 100 will be described.

As described above, the coin delivery operation of the coin dispenser 100 is controlled by the coin delivery control part 60 according to the coin delivery control data 610 stored in the storage part 61. A method for generating the coin delivery control data 610 will be described in detail later.

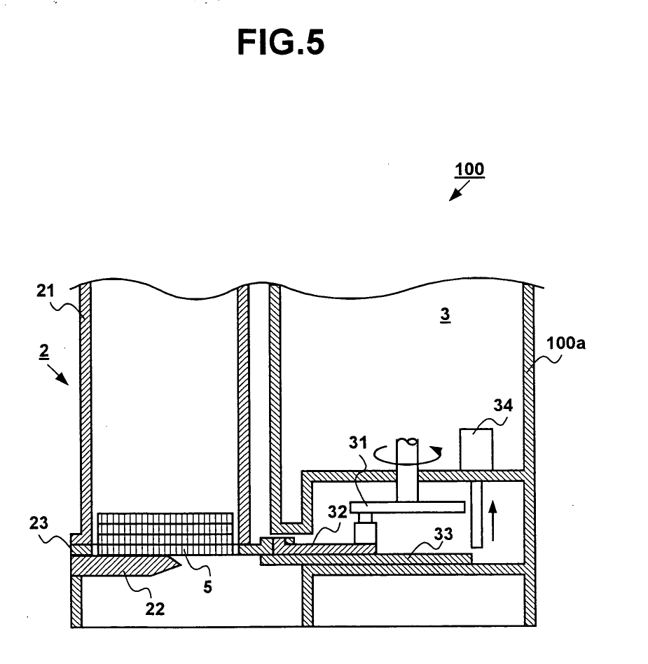

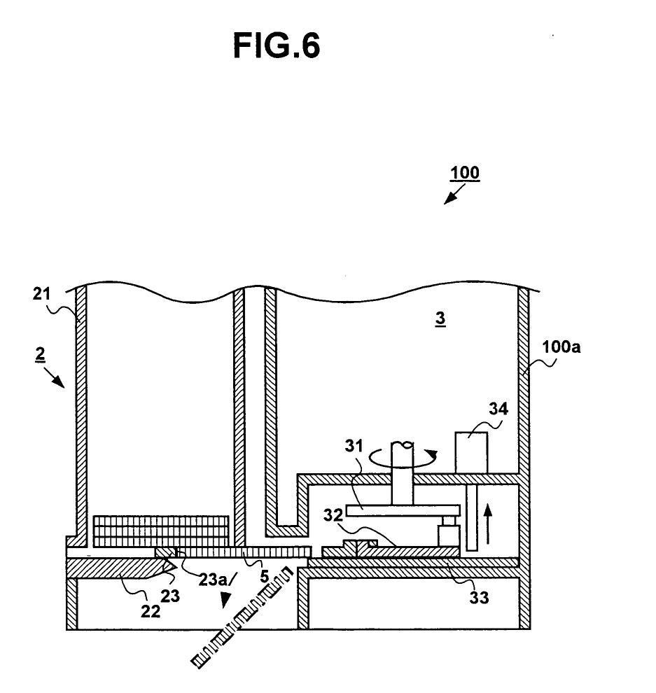

First, the coin delivery operation, when the coin tubes 21 have coins 5 and a coin delivery directive is given for their coin types, will be described with reference to FIG. 5 and FIG. 6.

In this case, among deliverability counters (not shown) corresponding to individual coin types in the coin delivery control part 60, the count of the deliverability counter for the pertinent coin type is 1 or more.

When the deliverability counter has a value of 1 or more, the coin delivery control part 60 can recognize that at least one coin 5 is within the pertinent coin tube 21. Therefore, when a coin delivery directive for delivering one coin 5 as change from the coin tube 21 is received, the coin delivery motor 35 is driven to rotate to start rotating the disc-shape delivery cam 31 as shown in FIG. 5.

At the time, the delivered coin selecting solenoid 34 for controlling the drive of the change slide 33 is turned ON at the same time to release the engagement between the pertinent solenoid 34 and the change slide 33.

Thus, the disc-shape delivery cam 31 is started to rotate, and when the solenoid 34 becomes ON, the engagement between the pertinent solenoid 34 and the change slide 33 is released. Therefore, when the delivery slide 23 is moved to the right via the delivery link 32 in the drawing and the coin 5 in the coin holding hole 23a is moved to the coin delivery position as shown in FIG. 6, the change slide 33 is also moved together with the delivery link 32 to the right in the drawing, and the coin 5 in the coin holding hole 23a is not supported its bottom face by the change slide 33. Thus, the coin 5 is dropped as indicated by a dash and dotted line and delivered as change.

To deliver the coin 5, the delivery slide 23 provided with the coin holding holes 23a corresponding to coins other than the coin 5 of pertinent coin type is commonly moved to slide. Therefore, it is necessary to control to stop delivering the coins 5 of coin types on which the coin delivery directive is not issued.

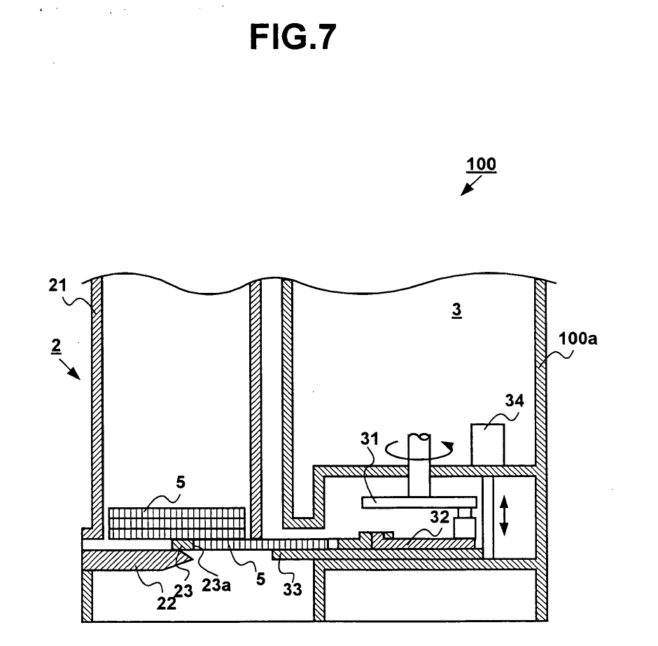

Then, a delivery suspension operation of coins 5 will be described with reference to FIG. 7 when the coin tubes 21 have coins which can be delivered and a coin delivery directive is not given for the coins of pertinent coin types to deliver a coin of another coin type.

In this case, the coin delivery control part 60 can recognize that the pertinent coin tubes 21 have at least one coin 5 because the deliverability counters for the coins of pertinent coin types indicate the count of at least 1 but has not received the coin delivery directive about the pertinent coin types, so that the drive of the delivered coin selecting solenoid 34 for controlling the drive of the change slide 32 for the pertinent coins 5 is turned OFF at the same time as shown in FIG. 7 before the disc-shape delivery cam 31 is rotated to deliver the coin of another coin type, and the solenoid 34 and the change slide 32 are kept engaged.

Then, when the disc-shape delivery cam 31 is rotated to make one turn by the coin delivery motor 35, the delivery slide 23 is moved to the right in the drawing via the delivery link 32 as shown in FIG. 7, and the coin 5 in the coin holding hole 23a is also moved to the coin delivery position.

At the time, the coin delivery control part 60 controls to keep OFF the delivered coin selecting solenoid 34 for controlling to drive the change slide 33, so that even when the delivery slide 23 is moved to the right in the drawing, the change slide 32 keeps the initial state by the delivered coin selecting solenoid 34. Therefore, the change slide 32 moves forward to the bottom of the coin holding hole 23a to limit the drop of the coin 5 housed within it.

Thus, when the coin 5 of another coin type is delivered, the coin 5 of pertinent coin type which is not given the coin delivery directive can be stopped from being delivered.

In FIG. 7, when the disc-shape delivery cam 31 is made to complete one turn by the coin delivery motor 35, the delivery slide 23 returns to the initial position at the bottom end of the coin tube 21.

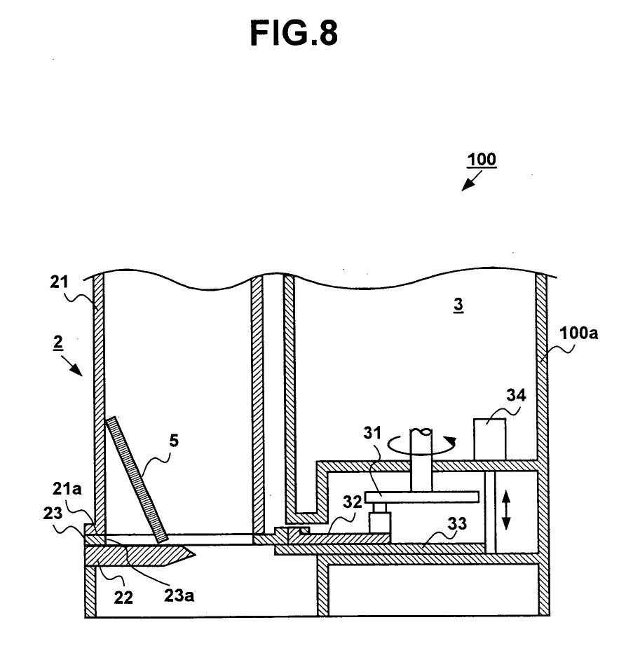

Then, a coin delivery operation will be described with reference to FIG. 8 to FIG. 10 when the coin tube 21 does not have a coin to be delivered (empty state), one coin 5 (coin 5 of coin type corresponding to the coin tube 21) is dropped into the coin tube 21 from the coin insertion port 11, and a coin delivery directive is given for the pertinent coin 5 only.

It is assumed that, when the coin tube 21 is empty, one coin 5 dropped into the coin tube 21 through the coin insertion port 11 stands on its edge in the coin tube 21 as shown in FIG. 8.

In this case, the count of the deliverability counter for the pertinent coin type is updated from 0 to 1, and the coin delivery control part 60 can recognize that the coin tube 21 for the pertinent coin type which did not have a coin 5 has become possible to deliver because one coin 5 was inserted.

When a coin delivery directive is input for only the coin 5 recognized to be deliverable before the coin delivery directive for the coin 5 of another coin type is issued, the coin delivery control part 60 performs the following coin delivery control.

In this case, the coin delivery control part 60 starts rotating the disc-shape delivery cam 31 from the state shown in FIG. 8 to perform a non-delivery operation (idle striking operation).

At this time, the coin delivery control part 60 turns OFF the drive of the delivered coin selecting solenoid 34 which controls the drive of the change slide 33 corresponding to the coin type and the drive of all the delivered coin selecting solenoids 34 corresponding to other coin types at the same time and keeps the engagement between these solenoids 34 and the corresponding change slides 33.

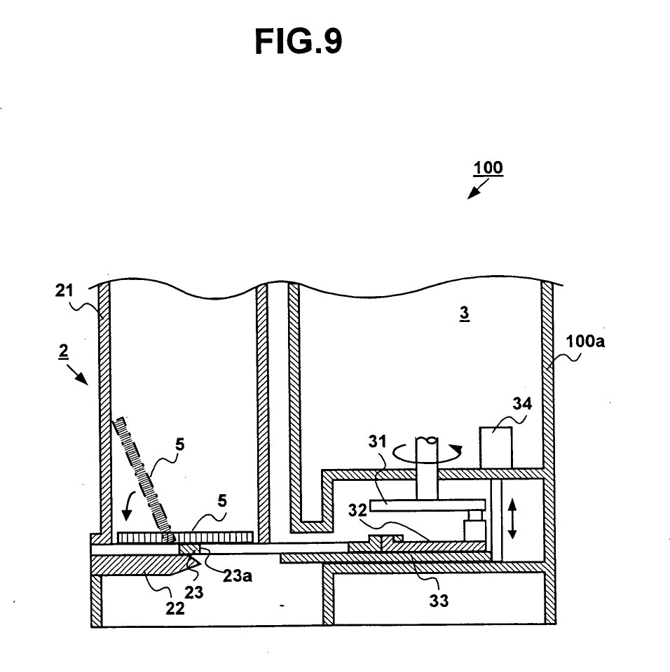

Thus, when the delivery slide 23 is moved to the right via the delivery link 32 in the drawing as shown in FIG. 9 while the disc-shape delivery cam 31 is turned a half-turn by the coin delivery motor 35, the coin 5 is fell down by the movement of the delivery slide 23 to become flat (standing coin state is remedied) so to be accumulated on the delivery slide 23.

Subsequently, when the disc-shape delivery cam 31 is further rotated a half-turn (to complete one turn) by the coin delivery motor 35, the delivery slide 23 returns again to the bottom end of the coin tube 21 so to return to the initial position.

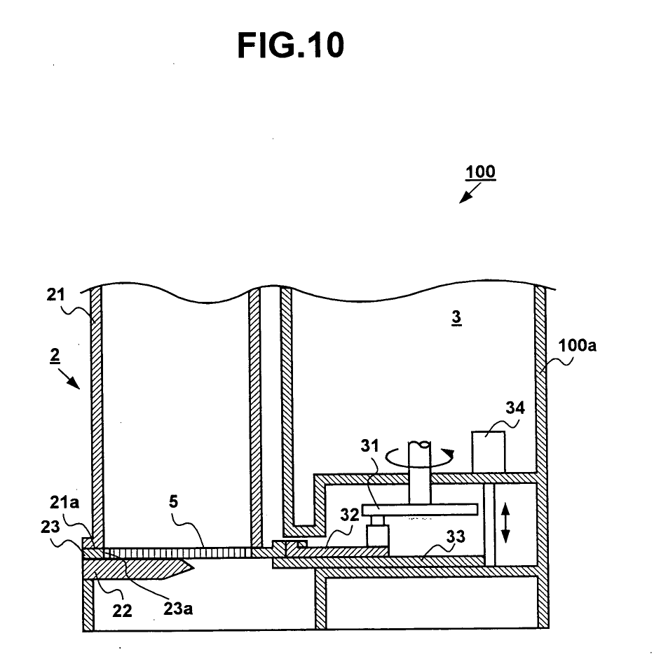

When the delivery slide 23 returns to the initial position, the coin 5 which has been remedied its standing state with timing shown in FIG. 9 is housed in the coin holding hole 23a of the delivery slide 23 having returned to the initial position as shown in FIG. 10.

Subsequently, the coin delivery control part 60 turns ON to drive the delivered coin selecting solenoid 34 for controlling the drive of the change slide 33 for the pertinent coin type to drive the disc-shape delivery cam 31 for another one turn with the solenoid 34 and the change slide 33 released from the mutual engagement, thereby capable of dropping to deliver the coin 5 from the coin holding hole 23 a of which support by the change slide 33 is released as described with reference to FIG. 5 and FIG. 6.

Thus, the coin dispenser 100 of the present invention is provided with the plurality of coin tubes 21 for the individual coin types, into which the coins 5 of pertinent coin types are dropped through the coin insertion port 11, and has a structure that the delivered coin selecting solenoids 34 which are disposed for the individual coin tubes 21 are turned ON/OFF while one delivery slide 23 having a plurality of coin holding holes 23a for accommodating the coins 5 of individual coin types is reciprocally moved by a single coin delivery motor 35, and the coins can be selectively delivered from any of the plurality of coin tubes 21.

When the coin tube 21 not having a coin 5 which can be delivered falls in a state that one coin 5 can be delivered because, for example, one coin 5 of pertinent coin type is inserted through the coin insertion port 11. Then, when a coin delivery directive for only the coin 5 which can be delivered is given from the main control part 65, only the coin delivery motor 35 is driven immediately before delivery of the coin 5 to turn OFF the delivered coin selecting solenoids 34 of all coin types so to make a single operation not to deliver the coin (non-delivery operation=idle striking operation), and control is made to deliver one coin 5 of the pertinent coin type.

Besides, even if the coin dispenser 100 has a coin tube 21 which can delivery and the con 5 can be delivered from the coin tube 21, when the coin 5 of another coin type is delivered before the pertinent coin 5 is delivered or a coin delivery directive is received together with the coin 5 of another coin type, it is controlled to deliver the coin 5 of pertinent coin type by one operation without performing the idle striking operation even if there is a coin delivery directive for the coin 5 which is in a deliverable state.

This control has a key factor in that attention has been given to the fact that, even if one coin 5 which is dropped in the empty coin tube 21 stands on its edge in the coin tube 5, it is mostly set in position when the next coin is dropped, and even if the first coin 5 stands on its edge in the coin tube 21, its standing state is resolved by idle sliding without delivering the pertinent coin 5, and the delivery is conducted by a minimum idle striking operation to shorten the delivery time and secure reliability.

Then, an operation of the coin dispenser 100 of the invention will be described in more detail.

First, inserted coin processing for generating control data required for control of the delivery operation of the coin 5 will be described.

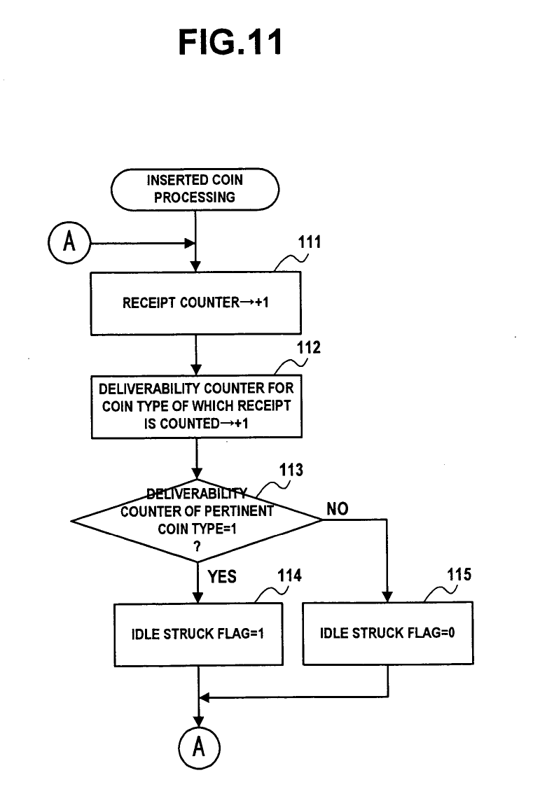

FIG. 11 is a flow chart showing an inserted coin processing of the coin dispenser 100 according to the invention.

In this coin dispenser 100, the coin 5, which is inserted through the coin insertion slot 11 and determined to be a genuine coin by the authenticity determination/sorting part 12 (its coin type is also determined when the authenticity is determined), is sorted to the genuine coin portion by the genuine/counterfeit coin dividing lever, sorted according to the coin types and guided into the coin tube 21 for pertinent coin type.

At this time, the authenticity determination/sorting part 12 inputs coin type information indicating the coin type of the coin 5 recognized by the above-described authenticity determination to the coin delivery control part 60.

A pass sensor (not shown), which is disposed in a route to the genuine coin portion, inputs a receipt detection signal to the coin delivery control part 60 every time it detects a coin 5 passing through the route.

Meanwhile, the coin delivery control part 60 has a receipt counter and a deliverability counter for each coin type.

In response to the above-described coin insertion operation, the coin delivery control part 60 adds 1 to the receipt counter every time the receipt detection signal is input from the pass sensor (step 111).

After adding up the receipt counter, the coin delivery control part 60 adds 1 to the deliverability counter for a coin type, which has counted the latest receipt according to the coin type information from the authenticity determination/sorting part 12 (step 112).

Then, the coin delivery control part 60 checks whether the deliverability counter for the pertinent coin type has a value 1 after the above-described adding up (step 113).

Here, when the deliverability counter for the pertinent coin type has a value 1 (YES in step 113), an idle struck flag for the pertinent coin type is set to “1” which indicates an idle striking operation (step 114).

In this case, the coin delivery control part 60 recognizes from the fact that the deliverability counter for the pertinent coin type has become “0” and then it is updated to “1” that one coin 5 is inserted to make it possible to deliver after the coin tube 21 for the pertinent coin type has become out of a coin 5 which can be delivered. In other words, the coin tube 21, which has changed from an empty state to a state having one coin in it, is recognized as an idle struck coin tube.

Under the state that the idle struck coin tube 21 is recognized, the introduced coin 5 may stand on its edge in the pertinent coin tube 21 as shown in, for example, FIG. 8. And, when the coin is standing on its edge, the above-described idle struck flag is set to “1” in view of necessity to perform a single idle striking operation to secure the coin delivery.

On the other hand, when the deliverability counter for the pertinent coin type does not have a value 1 (NO in step 113), an idle struck flag for the coin type is set to “0” which indicates that the idle striking operation is not performed (step 115).

The coin delivery control part 60 repeatedly performs the inserted coin processing consisting of the steps 111 to 115 every time a coin 5 is inserted through the coin insertion port 11.

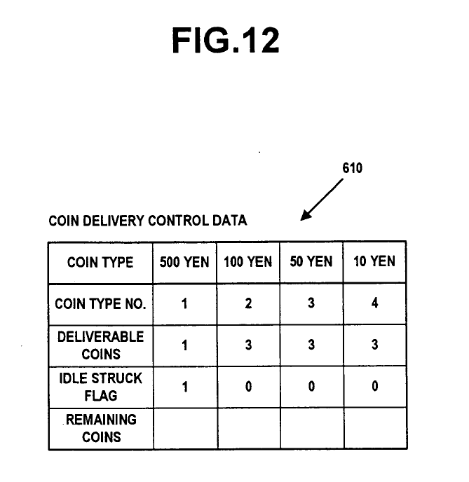

By the above-described inserted coin processing, the coin delivery control data 610 shown in, for example, FIG. 12 is provided in the storage part 61 of the coin delivery control part 60.

In this example, 500 yen, 100 yen, 50 yen and 10 yen coins handled by the coin dispenser 100 are discriminated by coin type Nos. 1, 2, 3 and 4, and one 500 yen coin and three of 100 yen, 50 yen and 10 yen coins each are recognized as the number of deliverable coins for each coin type.

As the idle struck flag for individual coin types, “1” is determined for the 500 yen coin and “0” for each of other coins of 100 yen, 50 yen and 10 yen.

Subsequently, when a coin delivery directive is given by the main control part 65, the coin delivery control part 60 sets the number of deliverable coins of each coin type corresponding to the coin delivery directive in the boxes of remaining coins corresponding to individual coin types in the coin delivery control data 610 (see FIG. 12) at the time and selectively drives the coin delivery motor 35 and the delivered coin selecting solenoids 34-1, 34-2, 34-3 and 34-4 corresponding to the individual coin types to perform the coin delivery operation according to the coin delivery directive.

Then, a coin delivery operation by the coin delivery control part 60 will be described.

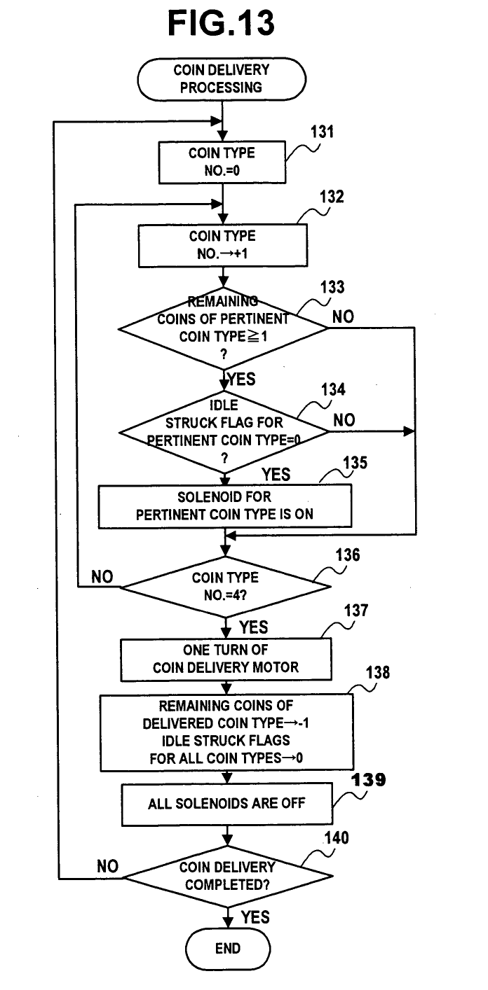

FIG. 13 is a flow chart showing a coin delivery operation of the coin delivery control part 60.

A coin delivery operation from the coin dispenser 100 is controlled by the coin delivery control part 60 according to the coin delivery control data 610 provided in the storage part 61 by the above-described inserted coin processing.

First, when a coin delivery directive is given from the main control part 65, the coin delivery control part 60 sets the remaining number of coins of each coin type according to the coin delivery directive in the boxes of remaining coins in the control data 610 stored in the storage part 61 and resets the coin type Nos. (step 131).

Then, “1” is added to the coin type No. (step 132), then the boxes of remaining coins of the coin type (500 yen in this case) corresponding to the coin type No. “1” as the added result is referenced to judge whether the remaining number of coins is 1 or more (step 133).

Here, when the remaining number of coins is 1 or more (YES in step 133), the idle struck flag box in the control data 610 is referenced to check whether the idle struck flag is “0” or not (step 134).

Here, if the idle struck flag is “0” (YES in step 134), the delivered coin selecting solenoid 34 for the pertinent coin type is turned ON (step 135).

Then, it is checked whether the coin type No. is “4” (step 136), and when the coin type No. is not “4” (NO in step 136), the procedure returns to step 132, “1” is added to the coin type No., and the coin type (100 yen in this case) corresponding to the coin type No. “2” as the added result is undergone steps 133 to 136.

Subsequently, the procedure of steps 132 to 136 is repeated sequentially for the coin type (50 yen in this case) corresponding to the coin type No. “3” and the coin type (10 yen in this case) corresponding to the coin type No. “4”.

Meanwhile, when the remaining number of coins of the pertinent coin type is not 1 or more in step 133 (NO in step 133) and when the idle struck flag for the pertinent coin type is not “0” in step 134 (NO in step 134), the procedure proceeds to step 136 with the delivered coin selecting solenoid 34 corresponding to the pertinent coin type kept OFF.

And, it is checked in step 136 whether the coin type No. is “4” or not, and when it is judged that the coin type No. is “4” (YES in step 136), the coin delivery control part 60 drives to rotate the coin delivery motor 35 for one turn (step 137).

At the time, in the coin tube 21 for the coin type having the relevant delivered coin selecting solenoid 34 turned ON in the previous step 135, the engagement between the solenoid 34 and the change slide 33 is released as shown in FIG. 5 and FIG. 6 (see FIG. 5). The delivery slide 23 is moved to the right via the delivery link 32 in the drawing by the rotation of the disc-shape delivery cam 31 and the coin 5 in the coin holding holes 23a is moved to the coin delivery position, and at the same time, the change slide 33 is also moved together with the delivery link 32 to the right in the drawing (see FIG. 6). Therefore, the coin 5 in the coin holding hole 23a is not supported its bottom face by the change slide 33, and the coin 5 drops as indicated by a dash and dotted line and delivered as a change coin.

Meanwhile, in the coin tube 21 for the coin type having the delivered coin selecting solenoid 34 kept OFF in the previous step 135, the engagement between the solenoid 34 and the change slide 33 is maintained as shown in FIG. 7. Therefore, even when the delivery slide 23 is moved to the right via the delivery link 32 in the drawing and the coin 5 in the coin holding hole 23a is moved to the coin delivery position by the rotation of the disc-shape delivery cam 31, the change slide 33 is limited its movement by the solenoid 34 and moved to the bottom of the coin holding hole 23a so to block the drop of the coin 5 housed therein, and the coin 5 of the pertinent coin type is not delivered.

As described above, after the coin delivery motor 35 is driven to make one turn, the coin delivery control part 60 processes to subtract 1 from the remaining number of coins of the coin type delivered, and sets the idle struck flags for all coin types to “0” (step 138).

Here, the idle struck flags for all coin types are set to “0” on the assumption that, when the delivery of one coin type is performed, even if the coin 5 of the coin type in the coin tube 21 of another coin type stands on its edge under the condition that it is recognized to be in a deliverable state as shown in, for example, FIG. 8, the standing coin is remedied by the reciprocal movement of the delivery slide 23 in the horizontal direction in the drawing in association with the delivery operation of the coin 5 of another coin type.

The coin 5 which is standing at the first coin delivery described above has the delivered coin selecting solenoid 34 OFF, so that the coin delivery is not conducted actually, and the remaining number of coins of pertinent coin type remains without being subtracted.

Specifically, for the coin 5 of the pertinent coin type, even if the coin delivery directive is made, only an idle striking operation is made for the first time (solution of the standing coin only), and the actual delivery is made by the next delivery operation.

After the processing in step 138 is completed, the coin delivery control part 60 returns the delivered coin selecting solenoids 34 corresponding to all the coin types to the OFF state (step 139).

Then, the coin delivery control part 60 refers to the boxes of remaining coins in the control data in the storage part 61 to check whether the delivery has completed (step 140), and if the delivery has not completed (NO in step 140), the procedure returns to step 131. Then, until it is judged that the delivery has completed (YES in step 140), namely until the remaining number of coins of all the coin types become “0”, a series of coin delivery processing (steps 131 to 140) is continued.

Then, an example of the coin delivery control data 610 and a coin delivery operation according to its control data 610 will be described.

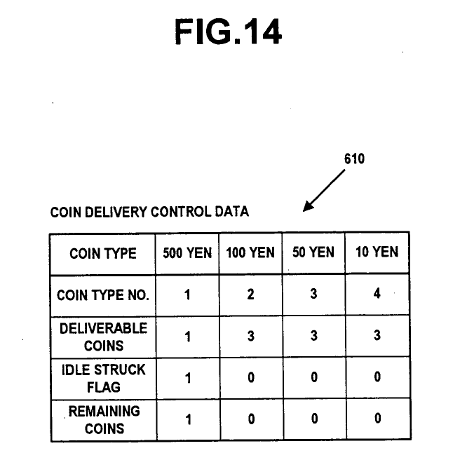

FIG. 14 is a diagram showing the details of the coin delivery control data 610 when change of 500 yen (500 yen coin×1) is delivered in a state the one coin is in the 500 yen tube, and three coins each are in the 100 yen tube, 50 yen tube and 10 yen tube.

In this case, it is assumed that the 500 yen coin dropped into the 500 yen tube is standing (see FIG. 8).

The coin delivery operation will be described below with reference to the flow chart of FIG. 13.

During the cyclic processing in steps 132 to 136, it is judged in step 133 that 500 yen coin is left after the delivery, and it is judged in step 134 that the idle struck flag for the pertinent 500 yen coin is “1”, so that the solenoid 34 for the 500 yen tube is turned OFF in order for the idle striking operation, the solenoids 34 for the other coin types are turned OFF because delivery is not required, and the coin delivery motor 35 is turned to make one turn in step 137.

Thus, for the 500 yen tube, the idle striking operation is performed to remedy the standing state of the 500 yen coin placed in the pertinent 500 yen tube as described with reference to FIG. 8 to FIG. 10, and for the other tubes, the change slides 33, which are limited their movement following the delivery link 32 because the corresponding solenoids 34 are OFF, move to the bottoms of the coin holding holes 23a of the delivery slide 23 as described with reference to FIG. 7, so that the individual coins are not delivered.

At this time, 500 yen coin is not delivered from the 500 yen tube because of the above-described idle striking operation, and the remaining number of coins related to the pertinent 500 yen coin remains to be “1” (but, the idle struck flag for the 500 yen coin is updated from “1” to “0”) in step 138. And, the delivery termination is not judged in step 140, and the procedure returns to step 131, and the next delivery operation is started.

In the next coin delivery operation, it is judged in step 133 that there is a remaining 500 yen coin after the delivery, and it is judged in step 134 that the idle struck flag for the 500 yen coin is “0”. Therefore, the solenoid 34 for the pertinent 500 yen tube is turned ON, and the solenoids 34 for the other coin types are turned OFF because the delivery is not necessary, and the coin delivery motor 35 is driven to rotate one turn in step 137.

At this time, the 500 yen tube is in a state that the standing coin state is remedied by the previous idle striking operation (a state housed in the coin holding hole 23a of the delivery slide 23: see FIG. 10), and, the 500 yen coin is delivered from the pertinent 500 yen tube through the procedure described with reference to FIG. 5 and FIG. 6 from the state of FIG. 10 by one rotation of the coin delivery motor 35.

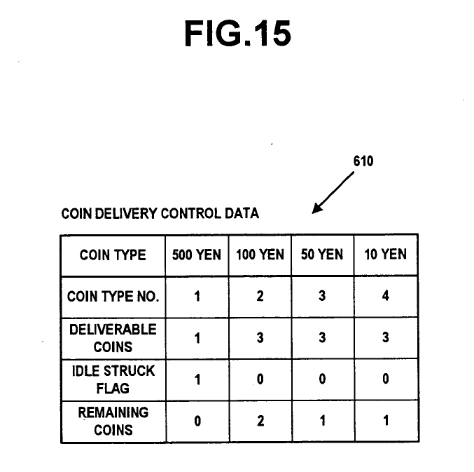

FIG. 15 is a diagram showing the details of the coin delivery control data 610 when the 500 yen tube has one coin and the 100 yen tube, the 50 yen tube and the 10 yen tube each have 3 coins, and 260 yen (100 yen coin×2, 50 yen coin×1 and 10 yen coin×1) change is to be delivered.

It is assumed that the 500 yen coin dropped into the 500 yen tube is in a standing state (see FIG. 8).

The coin delivery operation will be described with reference to the flow chart of FIG. 13.

In this case, during the cyclic processing in steps 132 to 136 for the first delivery operation, it is judged in step 133 that 100 yen coin, 50 yen coin and 10 yen coin each are remaining after the delivery, and it is judged in step 134 that the idle struck flags for the pertinent 100 yen coin, 50 yen coin and 10 yen coin are “0” respectively, the solenoids 34 for the 100 yen coin, 50 yen coin and 10 yen coin are turned ON, and the solenoid 34 for the 500 yen coin is turned OFF because its delivery is not required, then the coin delivery motor 35 is driven to make one turn in step 137.

At the time, the pertinent coins are delivered from the 100 yen tube, the 50 yen tube and the 10 yen tube by the procedure described with reference to FIG. 5 and FIG. 6.

Meanwhile, because the corresponding solenoid 34 for the 500 yen tube is in an OFF condition, the operation corresponding to the idle striking operation is performed by the procedure described with reference to FIG. 8 to FIG. 10, and the standing state of the 500 yen coin in the 500 yen tube is remedied.

As described above, the 100 yen coin, 50 yen coin and 10 yen coin are delivered by one rotation of the coin delivery motor 35, “1” is subtracted from the remaining number of individual coins in step 138, and the idle struck flag for the 500 yen coin is updated from “1” to “0”.

In such a state, there is remaining one 100 yen coin, so that the delivery termination is not judged in step 140, and the procedure returns to step 131, then the next delivery operation is started.

In the next delivery operation, during the cyclic processing in steps 132 to 136, it is judged in step 133 that there are remaining 100 yen coins, it is judged in step 134 that the idle struck flag for the pertinent 100 yen coin is “0”, the solenoid 34 corresponding to the 100 yen tube is turned ON, and the solenoids 34 for the other coin types are OFF because the delivery is not required, then the coin delivery motor 35 is driven to make one turn in step 137.

At this time, one 100 yen coin is delivered from the 100 yen tube by the procedure described with reference to FIG. 5 and FIG. 6, and the individual coins are not delivered from the tubes of the other coin types as the change slides 33, which are limited their movement following the delivery links 32 because the corresponding solenoids 34 are OFF, move to the bottoms of the coin holding holes 23a of the delivery slide 23.

Subsequently, the remaining number of 100 yen coin becomes “0” because “1” is subtracted in step 138, and it is judged in step 140 that the delivery has completed, and a series of coin delivery operations is terminated.

Then, if it is necessary to deliver 500 yen coin, the delivery operation can be performed immediately without conducting the idle striking operation even when there is only one 500 yen coin remained in the 500 yen tube because the pertinent 500 yen coin is remedied its standing state by the delivery of the coins of the other coin types and the idle struck flag is updated from “1” to “0”.

Thus, the coin dispenser 100 of the invention recognizes for each of the coin tubes 21 of individual coin types (recognizes according to the value counted by the deliverability counter) that one coin 5 is inserted through the coin insertion port 11 when no coin 5 is deliverable from the coin tube 21 and one coin 5 can be delivered now, and, when it receives a coin delivery directive for one coin of the coin type which is recognized to be deliverable, it controls to drive only the coin delivery motor 35 to perform a single idle striking operation immediately before the coin 5 which is recognized to be deliverable is delivered, and to drive the delivered coin selecting solenoid 34 and coin delivery motor 35 corresponding to the coin type for which the coin delivery directive is received so to deliver the coin 5 of the pertinent coin type.

Besides, even if it is recognized that one coin is placed in the empty coin tube 21 and can be delivered, when the delivery operation of a coin of another coin type is performed before the one coin which is recognized to be deliverable now is delivered or when the coin delivery directive is received together with another coin type, this coin dispenser 100 controls to deliver the coin of the pertinent coin type by a single operation without performing the above-described idle striking operation even if there is a coin delivery directive for the coin which is recognized to be deliverable after that.

It is assumed in the above embodiment that one coin is inserted when the coin tube 21 has no coin and it is standing on its edge in the coin tube 21, but there is also a possibility that the same standing state of the first coin may be caused when the second or third coin is inserted. Therefore, it may be configured to control the idle striking operation assuming that the standing coin takes place when plural coins are inserted.

In such a case, the coin delivery control part 60 recognizes for each coin type that the coin tube 21 can now delivery because coins were inserted in a range of n (n is any integer. For example, n=3) when the coin tube 21 has no coin in it.

Specifically, it is checked in step 113 during the inserted coin processing as shown in, for example, FIG. 11 whether the deliverability counter for each coin type exceeds n and, if it exceeds n, sets the idle struck flag to “0” (step 115), and if n or less, sets the idle struck flag to “1”.

The coin delivery control part 60 recognizes for each coin type by the above-described method that the coin tube 21 can delivery because coins are inserted in a range of up to n when the coin tube 21 has no coin in it, and when a coin delivery directive for a coin of coin type recognized to be deliverable is received and only when no coin of another coin type has been delivered before the pertinent coin delivery directive is given, it can perform the idle striking operation by driving only the coin delivery motor 35 one time and then drive the delivered coin selecting solenoid 34 for the coin type for which the coin delivery directive was received and the coin delivery motor 35 to deliver the coin of the pertinent coin type.

It is apparent from the above two embodiments that the coin dispenser of the invention separately counts the coins 5 accumulated in the coin tubes 21, detects as an idle struck coin tube according to the counted value a coin tube 21 which contains a prescribed number or less of coins and in which a coin is newly accumulated, and, when a coin 5 is to be delivered and only when the idle struck coin tube 21 is detected, executes the idle striking operation to perform the delivery operation in a state that the delivery of the coin 5 from the pertinent coin tube 21 is prohibited

By configuring as described above, it is not necessary to perform the idle striking operation every time change is delivered for each sale, and the change delivery time can be shortened by the number of times of idle striking operations.

Because it is not necessary to perform a single idle striking operation for each sale, the operation lives of the respective drive mechanisms such as the delivered coin selecting solenoids 34 and the delivery slide 23 for the coin delivery can be extended accordingly.

The present invention is not limited to the embodiments described above and shown in the drawings and can be appropriately modified for implementation without departing from the spirit and scope thereof.

For example, the coins handled by the coin dispenser of the invention are not limited to the above-described four coin types and may be of more or less coin types.

And, the coin dispenser of the invention is not limited to automatic vending machines but may also be applied to any type of equipment, such as money changers, service equipment, having a function to deliver the inserted coins as change.

### INDUSTRIAL APPLICABILITY

The present invention provides a coin dispenser which is reduced its number of idle striking operations and capable of shortening the coin delivery time and extending the operation lives of the coin delivery mechanisms, and a control method for the coin dispenser. A coin tube having a prescribed number or less of accumulated coins and receiving another coin newly is detected as an idle struck coin tube, and only when the idle struck coin tube is detected when a coin is delivered by coin delivery means, the idle striking operation for performing the delivery operation is executed with the delivery of a coin from the pertinent coin tube prohibited. Therefore, it is not necessary to perform the idle striking operation every time the coin delivery is made, the coin delivery time can be shortened substantially, and the number of idle striking operations is reduced. Accordingly, the operation lives of the respective mechanisms for the coin delivery can be extended, contributing to the improvement of the reliability of the coin delivery processing.

1. A coin dispenser which includes a plurality of coin tubes for storing inserted coins by coin type and coin delivery means for selectively delivering coins from bottom ends of the coin tubes, comprising:
coin counter means for counting coins accumulated in each of the coin tubes;
detection means for detecting, as an idle struck coin tube, a coin tube having a prescribed number or less of accumulated coins, in which another coin is newly accumulated, according to count outputs of the coin counter means; and
delivery control means for executing, at the time of delivering coins by the coin delivery means, an idle striking operation in which a delivery operation is performed in a state that coins are prohibited to be delivered from the idle struck coin tube, only when the idle struck coin tube is detected by the detection means.

2. The coin dispenser according to claim 1, wherein:
the coin delivery means comprises:
a coin delivery motor;
a delivery slide which is driven by the coin delivery motor to pull out coins from the bottom of the coin tubes one by one;
delivered coin selecting solenoids each being provided in association with each of the coin tubes; and
change slides which are selectively driven according to ON/OFF of the delivered coin selecting solenoids and which control delivery and non-delivery of the pulled-out coins by switching between a state of releasing and a state of supporting bottom faces of the coins of respective coin types pulled out by the delivery slide, and
the delivery control means executes the idle striking operation by rotating the coin delivery motor while holding the change slide in the bottom face supporting state by means of the delivered coin selecting solenoid associated with the idle struck coin tube.

3. The coin dispenser according to claim 1, wherein the detection means detects a coin tube, which has been empty and received a coin newly, as the idle struck coin tube.

4. The coin dispenser according to claim 1, wherein the delivery control means cancels the detection of the idle struck coin tube when a coin is delivered from another coin tube after the idle struck coin tube is detected by the detection means.

5. A method for controlling a coin dispenser which accumulates inserted coins in a plurality of coin tubes separately by coin type and selectively delivers the coins from bottom ends of the plurality of coin tubes, the method comprising:
counting the coins accumulated in each of the coin tubes;
detecting a coin tube, which has a prescribed number or less of accumulated coins and received a coin newly, as an idle struck coin tube according to the counted result; and
executing, at the time of delivering coins by the coin delivery means, an idle striking operation in which a delivery operation is performed in a state that coins are prohibited to be delivered from the idle struck coin tube, only when the idle struck coin tube is detected.

6. The method for controlling a coin dispenser according to claim 5, wherein:
a delivery slide, which pulls out coins one by one from bottom ends of the coin tubes, is driven by means of a coin delivery motor, and change slides are switched between a state of releasing and a state of supporting the coins of respective coin types pulled out by the delivery slide according to ON/OFF of delivered coin selecting solenoids each provided in association with each of the coin tubes, so as to control delivery and non-delivery of the pulled-out coin; and
the idle striking operation is executed by rotating the coin delivery motor while holding the change slide in the bottom face supporting state by means of the delivered coin selecting solenoid associated with the idle struck coin tube.

7. The method for controlling a coin dispenser according to claim 5, wherein the idle struck coin tube is a coin tube which has been empty and received one coin newly.

8. The method for controlling a coin dispenser according to claim 5, wherein the detection of the idle struck coin tube is cancelled when a coin is delivered from another coin tube after the idle struck coin tube is detected by the detection means.
